(19) United States
(12) Patent Application Publication
(10) Pub. No.: US 2022/0152629 A1
(43) Pub. Date: May 19, 2022

(54) TUNEABLE DIELECTROPHORETIC SEPARATION & CONCENTRATION DEVICE WITH INTEGRATED NANO- OR MICROPORE DETECTOR

(71) Applicants: ARIZONA BOARD OF REGENTS ON BEHALF OF ARIZONA STATE UNIVERSITY, SCOTTSDALE, AZ (US); UNIVERSITY OF RHODE ISLAND BOARD OF TRUSTEES, Kingston, RI (US)

(72) Inventors: Mark Hayes, Gilbert, AZ (US); Jason Dwyer, Providence, RI (US); Alexis Ramirez, Tempe, AZ (US); Brian Sheetz, Fort Collins, CO (US)

(21) Appl. No.: 17/531,284

(22) Filed: Nov. 19, 2021

Related U.S. Application Data
(60) Provisional application No. 63/115,958, filed on Nov. 19, 2020.

(51) Int. Cl. B03C 5/00

(52) U.S. Cl. CPC B03C 5/005; B03C 2201/24

(57) ABSTRACT

The present disclosure provides a system including an insulator-based dielectrophoresis device. The insulator-based dielectrophoresis device includes a fluid flow channel having at least one fluid inlet and at least one fluid outlet. The fluid flow channel includes at least one insulating flow structure extending from a wall to define a constriction in the fluid flow channel. The system includes a detection chamber placed in fluid communication with the fluid flow channel by an opening in the wall of the fluid flow channel, where the opening is configured downstream of the at least one insulation flow structure. The detection chamber includes an electrochemical sensor configured to constrict the flow of fluid entering the detection chamber through a pore, where the pore is sized to produce a detectable signal upon passage of an analyte through the pore. The system may process the detectable signal to output a metric indicative of the identity or physiochemical property of the analyte.

### CROSS-REFERENCE TO RELATED APPLICATIONS

This application claims priority to and the benefit of U.S. Patent Application No. 63/115,958 filed on Nov. 19, 2020, all of which is incorporated by reference in its entirety.

### STATEMENT REGARDING FEDERALLY SPONSORED RESEARCH

Not applicable.

### BACKGROUND

In the last several years the exploitation of microfluidics as a method for analyte manipulation has grown rapidly, particularly for biological samples. This is driven by the current limitations of diagnostic methods, especially the need for large sample volumes, lengthy analysis times, and low resolution/sensitivity. Microfluidic devices have the potential to improve each of these figures of merit and provide for easy portability and the use on a wide range of analytes including bioparticles. Among the latter class: animal cells, organelles, proteins, vesicles, RNA, glycans, exosomes, lipids DNA and bacteria have been probed.

One major division of microfluidics uses electrokinetic (EK) and the dielectrophoretic (DEP) forces on particles (molecules are considered particles for the purposes of this discussion). The EK forces allows for the manipulation of both the particle and the suspending medium, as it is the sum of electrophoresis and electroosmosis. DEP is the force that is exerted on a polarizable particle present in a non-uniform electric field (E). Utilizing EK and DEP forces, trapping and streaming of particles is possible. This allows for the separation of analytes based on their specific and subtle electrical physical properties.

Previous work on DEP separations has utilized electrode-based dielectrophoresis (eDEP) for separations, which has the advantage of being able to induce high field gradients with a low applied voltage. Fabrication of eDEP devices is difficult and expensive, which is made worse as electrodes are easily fouled, rendering the channels non-reusable. The electrodes cause further issues as electrolysis-created bubbles and the high gradients are only local to the electrodes. DEP devices provide a method for separating a complex sample matrix into individual components. Although current DEP devices may separate a complex sample matrix into individual components with high selectivity, existing devices do not include integrated techniques to characterize the separated bioparticles.

Nanopore sensors are known for detecting individual species passing through a nanoscale pore. However, nanopore sensors suffer from long analysis times at low analyte concentration, and can produce non-specific signals that are unrecognizable in complex media (i.e., a mixture of multiple analytes). While nanopore sensing is sensitive to single molecules, it typically requires analyte concentrations greater than nanomolar in order to achieve reasonable analyte count rates.

### SUMMARY OF THE DISCLOSURE

The present disclosure addresses the aforementioned shortcomings by providing integrated devices and methods that (i) separate a fluid mixture containing multiple analytes using gradient insulator-based dielectrophoresis (g-iDEP) into selected, individual analytes and (ii) transport the selected analyte to a nanopore within the device for characterization and/or detection. The devices and methods provided herein allow for smart, electrically-tuned single-molecule sensing in addition to simultaneous separation of a complex fluid mixture.

The provided devices and methods offer advantages over current systems. First, the provided devices and methods allow for simultaneous separation, concentration, characterization and/or detection of the analytes of interest. If the provided fluid mixture contains analytes at a concentration insufficient for detection using a nanopore sensor, the provided devices and methods may concentrate an individual analyte within the fluid mixture to a concentration that is sufficient for detection with an integrated nanopore sensor. Second, the provided devices and methods may include multiple insulating flow structures within the g-iDEP device that selectively separate analytes of interest within the fluid mixture. In this way, analytes that are not separated by the insulating flow structures may be transported through the g-iDEP device to a nanopore sensor for characterization and/or discrimination.

Further, fabrication of eDEP devices is difficult and expensive, which is made worse as electrodes are easily fouled rendering the channels non-reusable. The electrodes cause further issues as electrolysis-created bubbles and the high gradients are only local to the electrodes. Unlike eDEP, g-iDEP is an alternative to induce non-uniform electric fields in a microchannel where the electrodes are placed in distal inlet and outlet reservoirs and the electric field is defined by channel insulators and the conductive media. This resolves many of the issues encountered with eDEP (electrolysis, bubbles, fouling). Both AC and DC fields can be used with iDEP as DC fields drive overall particle movement since it induces EK and DEP transport and AC can refine separations influencing DEP only.

The present disclosure provides a system. In some embodiments, the system includes a dielectrophoresis device having a fluid flow channel defined by a first substrate surface and a second substrate surface spaced from the first substrate surface. The fluid flow channel further includes at least one fluid inlet and at least one fluid outlet. The dielectrophoresis device includes at least one insulating flow structure extending from the first substrate surface toward the second substrate surface thereby defining a constriction in the fluid flow channel between the first substrate surface and the second substrate surface. In some embodiments, the system includes a detection chamber placed in fluid communication with the fluid flow channel by an opening in either the first substrate surface or the second substrate surface, where the opening is configured downstream of the insulation flow structure. In some embodiments, the detection chamber includes at least one electrochemical sensor configured to constrict the flow of fluid in the fluid flow channel through a pore. The pore may be sized to produce a detectable signal upon passage of one or more analyte near, into, or through the pore. In some embodiments, the system includes electrodes in electrical communication with the at least one fluid channel inlet and the at least one fluid outlet of the fluid flow channel. The electrodes are positioned to generate a spatially non-uniform electric field across the insulating flow structure of the fluid flow channel to exert a dielectrophoretic force on one or more analyte suspended in the fluid within the fluid flow chamber. In some embodiments, the system includes a power supply connected to each of the electrodes to generate an electric field within the fluid flow channel.

In some embodiments, the pore is a nanopore. In some embodiments, the nanopore has a diameter that is no more 100 nm wide in diameter, or no more than 50 nm wide in diameter, or no more than 40 nm wide in diameter, or no more than 30 nm wide in diameter, or no more than 20 nm wide in diameter, or no more than 10 nm wide in diameter.

In some embodiments, the pore is a micropore. In some embodiments, wherein the micropore has a diameter that is no more than 100 μm in diameter, or no more than 50 μm wide in diameter, or no more than 40 μm wide in diameter, or no more than 30 μm wide in diameter, or no more than 20 μm wide in diameter, or no more than 10 μm wide in diameter.

In some embodiments, the fluid flow channel includes a first insulating flow structure and a second insulating flow structure, where the detection chamber is positioned between the first insulation flow structure and the second insulating flow structure.

In some embodiments, the electrochemical sensor includes a substrate formed from a material selected from a polymer, silicon nitride, graphene, or molybdenum disulfide.

In some embodiments, the pore includes a functional group coupled to a surface of the pore. The functional group may be an organic molecule, a protein, or a material compatible with atomic layer deposition.

In some embodiments, the at least one insulating flow structure is configured to selectively separate a first analyte from the fluid, and allows passage of a second analyte.

In some embodiments, the insulator-based dielectrophoresis device includes a plurality of insulating flow structures in the fluid channel, wherein each of the plurality of insulating flow structures are configured to form a constriction in the fluid flow channel.

In some embodiments, the plurality of insulating flow structures includes a first insulating flow structure configured to selectively separate a first analyte from the fluid flow channel, and a second insulating flow structure configured to selectively separate a second analyte from the fluid flow channel, wherein the first insulating flow structure and the second insulating flow structure each have a constriction that allows passage of a third analyte.

In some embodiments, the fluid flow channel is a microchannel or a nanochannel.

In some embodiments, the system further includes a control system in electrical communication with a memory, the electrochemical sensor, the electrodes, and the power supply. The control system is configured to execute instructions stored within the memory to cause the control system to: (i) detect the detectable signal produced from the analyte passing through the pore of the electrochemical sensor, and (ii) output a metric indicative of the analyte based on the detectable signal. In some embodiments, the metric indicative of the analyte includes identification of the analyte, size, charge, charge distribution, charge polarity, conformation, monomer sequence in a polymer, polymer branching, particle coating, conformational stability, pKa, shape, passage time through the pore, mobility, interaction with the pore or other species in solution, or combinations thereof.

In some embodiments, the detectable signal includes a resistive pulse indicative of the analyte bouncing against the pore.

In some embodiments, the pore includes a functional group that binds the analyte, and wherein the detectable signal is indicative of a captured analyte within the pore.

In some embodiments, the system includes an array of electrochemical sensors, each configured to constrict the flow of fluid in the fluid flow channel through a respective pore, wherein the respective pore is sized to produce a detectable signal upon passage of an analyte through the pore.

The present disclosure provides a method. In some embodiments, the method includes separating and characterizing a first analyte from at least a second analyte in a fluid mixture. The method includes transporting a fluid mixture comprising a first analyte and at least a second analyte through a system comprising an insulator-based dielectrophoresis device comprising a fluid flow channel defined by a first substrate surface and a second substrate surface spaced from the first substrate surface, the fluid flow channel having at least one fluid inlet and at least one fluid outlet, and at least one insulating flow structure extending from the first substrate surface toward the second substrate surface thereby defining a constriction in the fluid flow channel between the first substrate surface and the second substrate surface. The system further includes a detection chamber placed in fluid communication with the fluid flow channel by an opening in either the first substrate surface or the second substrate surface, where the opening is configured downstream of the at least one insulating flow structure. In some embodiments, the detection chamber includes an electrochemical sensor configured to constrict the flow of fluid entering the detection chamber through a pore, wherein the pore is sized to produce a detectable signal upon passage of one or more analyte through the pore. The system further includes electrodes in electrical communication with the at least one fluid channel inlet and the at least one fluid outlet of the fluid flow channel, where the electrodes are positioned to generate a spatially non-uniform electric field across the insulating flow structure of the fluid flow channel to exert a dielectrophoretic force on the one or more analyte suspended in the fluid within the fluid flow channel. In some embodiments, the system further includes a power supply connected to each of the electrodes to generate an electric field within the fluid flow channel. In some embodiments, the method further includes separating at least the second analyte from the first analyte by passing the fluid mixture through the constriction, and transporting the first analyte through the pore of the electrochemical sensor to produce the detectable signal.

In some embodiments, the method include detecting the detectable signal using the electrochemical sensor, and outputting a metric indicative of the analyte based on the detectable signal.

These and other advantages and features of the present invention will become more apparent from the following detailed description of the preferred aspects of the present invention when viewed in conjunction with the accompanying drawings.

### DESCRIPTION OF THE DRAWINGS

FIG. 1 is a schematic illustration of a system for separating and characterizing and/or detecting an analyte from a fluid mixture in accordance with some embodiments of the present disclosure.

FIG. 2 is a flow chart illustrating a method of separating and characterizing a first analyte from a second analyte in a fluid mixture in accordance with some embodiments of the present disclosure.

### DETAILED DESCRIPTION

Before the present disclosure is described in further detail, it is to be understood that the invention is not limited to the particular embodiments described. It is also to be understood that the terminology used herein is for the purpose of describing particular embodiments only, and is not intended to be limiting. The scope of the present invention will be limited only by the claims. As used herein, the singular forms “a”, “an”, and “the” include plural embodiments unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements.

In some embodiments, the present disclosure provides systems and methods for separating a first analyte from at least a second analyte within a fluid mixture, and characterizing and/or detecting properties associated with at least the first analyte. In some embodiments, the systems provided herein contain a dielectrophoresis device, such as a gradient insulator-based dielectrophoresis device (g-iDEP).

As used herein, the term “Dielectrophoresis” (hereinafter “DEP”), is an electrodynamic transport mechanism with a nonlinear dependence on electric field. A non-uniform electric field produces an unequal electrodynamic force on the charge of a particle producing a net movement of the particle toward the region of higher electric field gradient. The resulting motion is called dielectrophoresis and can occur in either direct (hereinafter “DC”), alternating (hereinafter “AC”) electric fields, or a combination of both AC and DC. Insulator-based dielectrophoresis (iDEP) is an alternative to conventional electrode-based dielectrophoresis (eDEP) systems. In iDEP, insulating structures are used to generate nonuniform electric fields. iDEP method differs from traditional DEP separation in that a voltage, created by either DC, AC, or a combination of DC and AC, is applied to electrodes located in remote inlet and outlet reservoirs and the field nonuniformities are generated by arrays of insulating posts located within the channel.

iDEP offers several advantages compared with traditional DEP. The use of remote electrodes avoids many of the problems associated with embedded electrodes, such as electrochemical reactions and bubble generation at the electrode surfaces. Additionally, the use of DC voltages in eDEP creates many issues, which are not encountered in iDEP. The use of a DC field can be advantageous because it can be used to drive both electrophoretic and dielectrophoretic transports, allowing greater control over particle movement.

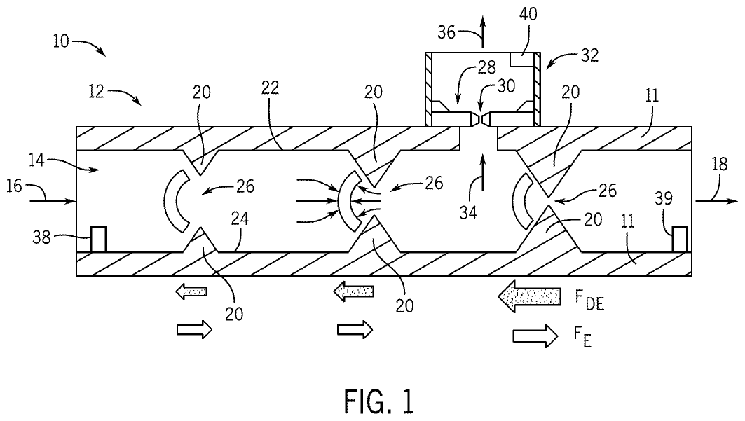

Referring to FIG. 1, the present invention provides a system 10 that includes an insulator-based dielectrophoresis (“iDEP”) device 12 for separating at least one analyte from a fluid mixture. The iDEP device 12 comprises one or more fluid flow channels 14, which may be formed from at least one substrate 11. The fluid flow channels 14 comprise at least one fluid inlet 16 and at least one fluid outlet 18. The fluid flow channels 14 include at least one insulating flow structure 20. In some embodiments, the at least one insulating flow structure 20 extends from a first substrate surface 22 toward a second substrate surface 24 thereby defining a constriction 26 in the fluid flow channel 14 between the first substrate surface 22 and the second substrate surface 24. The first and second substrate surface 22, 24 may be formed on the same substrate 11 (e.g., opposing surfaces in a channel) or may be on different substrates positioned proximate to one another.

In some embodiments, the system 10 includes one or more detection chamber 32 in fluid communication with the fluid flow channel 14. An opening 34 in the first substrate surface 22 (or the second substrate surface 24) may place the detection chamber 32 in fluid communication with the fluid flow channel 14. Although not depicted in FIG. 1, a gate or valve may be placed in opening 34. The gate or valve is movable from a closed position to an open position to allow passage of an analyte into the detection chamber 32. Fluid may exit the detection chamber 32 through a detection chamber outlet 36, which also may be regulated with a second gate or valve. Alternatively, the detection chamber 32 may be enclosed by walls. The detection chamber 32 includes an electrochemical sensor 28 that is configured to constrict the flow of fluid entering the detection chamber 32 through a pore 30. In some embodiments, the pore 30 is sized to produce a detectable signal upon passage of an analyte through the pore 30.

In some embodiments, the detection chamber 32 includes one or more electrode(s) 40. The one or more electrode(s) 40 may be positioned in the detection chamber 32, for example, in or adjacent to either the outlet 36 and/or the inlet 34 (electrode in inlet 34 not depicted in FIG. 1). In some embodiments, the one or more electrode(s) 40 transports analytes to the detection chamber 32 by biasing the spatially non-uniform electric field, e.g., electrode 40 could work in tandem with either electrode 38 or 39 to direct analytes to the detection chamber 32. Additionally or alternatively, an additional electrode (not shown in FIG. 1) could be positioned on the second substrate surface 24 opposite to opening 34, where the additional electrode and electrode 40 could bias the spatially non-uniform electric field to bias analytes toward the detection chamber 32.

In some embodiments, the electrochemical sensor 28 detects the detectable signal through resistive pulse sensing. Although FIG. 1 depicts a single detection chamber 32 positioned between two insulating flow structures 20, it is to be appreciated that the system 10 may include a plurality of detection chambers 32 positioned along the fluid flow channel 14. In some embodiments, a detection chamber 32 is positioned between each of the insulating flow structures 20.

The one or more detection chamber 32 may be orientated within the system 10 in a variety of ways. For example, the detection chamber 32 may be configured on a surface of the fluid flow channel 14, e.g., a side wall, top wall, or bottom wall of the fluid flow channel 14.

In some embodiments, the system 10 includes at least an inlet electrode 38 and an outlet electrode 39 in electrical communication with the at least one fluid channel inlet 14 and the at least one fluid outlet 18 of the fluid flow channel 14. The electrodes 38, 39 may be positioned to generate a spatially non-uniform electric field across the insulating flow structure 20 of the fluid flow channel 14 to exert a dielectrophoretic force on analytes suspended in the fluid within the fluid flow channel 14. In some embodiments, the system 10 includes a power supply (not illustrated) connected to each of the electrodes 38, 39 to generate an electric field within the fluid flow channel.

In some embodiments, the detection chamber 32 extends from the first substrate surface 22 to the second substrate surface 24 to constrict the flow of fluid in the fluid flow channel through the pore 30.

In some embodiments, the substrate 11 and/or the electrochemical sensor 28 is formed from a material selected from a polymer, silicon nitride, graphene, molybdenum disulfide, boron nitride, any viable two-dimensional films, silicon dioxide, and combinations thereof. In some embodiments, the pore 30 includes a functional group or coating coupled to a surface of the pore 30. The functional group may be selected from an organic molecule, a protein, a material compatible with atomic layer deposition including, but not limited to, HfO₂, TiO₂, sulfides, alumina, silicates, perovskite—among a large number of inorganic and organic moieties, or combinations thereof. In some embodiments, the functional group or coating may provide passivation, antifouling capacity, and/or implement a desired interaction between the solution or analyte molecule and the surface of the pore.

As used herein, the term “pore” or “constriction” refers to an aperture in the electrochemical sensor 28 or the fluid flow channel 14 that allows fluid within the fluid flow channel 14 to pass therethrough. In some embodiments, the pore 30 or the one or more constriction 26 is a micropore having a dimension (e.g., diameter) of no more than 1 mm, or no more than 750 μm, or no more than 500 μm, or no more than 250 μm, or no more than 100 μm, or no more than 50 μm wide in diameter, or no more than 40 μm wide in diameter, or no more than 30 μm wide in diameter, or no more than 20 μm wide in diameter, or no more than 10 μm wide in diameter. In some embodiments, the micropore may have a dimension from 1 μm to 1 mm. In some embodiments, the pore 30 or the one or more constriction 26 is a nanopore having a dimension (e.g., diameter) of no more than 1 μm, or no more than 750 nm, or no more than 500 nm, or no more than 250 nm, or no more than 100 nm in diameter, or no more than 50 nm wide in diameter, or no more than 40 nm wide in diameter, or no more than 30 nm wide in diameter, or no more than 20 nm wide in diameter, or no more than 10 nm wide in diameter.

As used herein, the term “channel” refers to a structure wherein a fluid may flow. A channel may be a capillary, a conduit, a chamber, a strip of hydrophilic pattern on an otherwise hydrophobic surface wherein the fluid mixture is confined. In some instances, the channel may be a microchannel or a nanochannel. In some embodiments, the device or system is a microfluidic device having one or more fluidic channels that are generally fabricated at the millimeter to nanometer scale.

In some embodiments, the fluid flow channels 14 are “microfluidic channels” or alternatively referred to herein as “microchannels.” Microchannels generally have cross-sectional dimensions below 1 mm, or ranging from 1000 nm to 1 mm. In some embodiments, the microchannel have a cross-sectional dimension of at least 1 μm, or at least 250 μm, or at least 500 μm, to less than 750 μm, or less than 1 mm. The dimensions of the microchannels are dependent on the desired effect on the analyte. As provided herein, the microfluidic channels may be formed in a substrate made of insulating material(s), such as polymers, glass, and the like.

In some embodiments, fluid flow channel 14 are “nanofluidic channels” or alternatively referred to herein as nanochannels. Nanochannels generally have cross-sectional dimensions below 1 μm, or ranging from 3 nm to 1 μm, or from 3 nm to 500 nm, or from 3 nm to 100 nm. In some embodiments, the microchannel have a cross-sectional dimension of at least 3 nm, or at least 10 nm, or at least 100 nm, or at least 250 nm, or at least 500 nm, to less than 750 nm, or less than 1 μm. The dimensions of the nanochannels are dependent on the desired effect on the analyte.

As used herein, “analyte” is used interchangeably with “particle” to refer to a particle that may be natural, synthetic chemicals, inorganic particles, or biological entities (biomolecules, bioparticles).

Suitable natural or synthetic chemicals or biological entities can include, but are not limited to, for example, micro-organisms, amino acids, peptides, proteins, glycoproteins, nucleotides, nucleic acid molecules, carbohydrates, lipids, lectins, cells, viruses, viral particles, bacteria, organelles, spores, protozoa, yeasts, molds, fungi, pollens, diatoms, toxins, biotoxins, hormones, steroids, immunoglobulins, antibodies, supramolecular assemblies, ligands, catalytic particles, zeolites, and the like, biological and chemical agents, drugs, prodrugs and metabolites, and the like, magnetic particles, high-magnetic-permeability particles, deuterated compounds, metal ions, metal ion complexes, inorganic ions, inorganic ion complexes, isotopes, organometallic compounds, metals including aluminum, arsenic, cadmium, chromium, selenium, cobalt, copper, lead, silver, nickel, and mercury, and the like, industrial polymers, powders, latexes, emulsions, colloids, environmental pollutants, pesticides, insecticides.

In some embodiments, the analyte may be a cell, for example, a human cell, a blood cell, a stem cell or progenitor stem cells. In some embodiments, the present device may be used to separate out differentiating stem cells from a culture.

In some embodiments, the methods and devices of the present invention may be used to isolate and concentrate stem cells based on their progenitor stage (i.e. at different stages of differentiation).

In other embodiments, the analyte may be a bacteria. In some embodiments, the separation of different bacterial strains or serotypes is contemplated. For example, in one example, the ability to isolate resistant versus susceptible bacteria to a specific antibiotic is contemplated.

In other embodiments, the analyte may have a crystalline structure, for example a crystalline structure in a composition derived from crystal growing and used in crystallography.

In some embodiments, the device is used to separate at least one analyte from a fluid. As used herein, “separating” refers to removing a given analyte from its initial environment which may include removing analytes of one or more species of interest from analytes of different or other species. In some embodiments, one type of analyte may be separated from another type (a second analyte). In some embodiments, more than two analytes can be separated. In some embodiments, the method involves separating the analytes from contaminants or other debris within the fluid. In some embodiments, methods of using the device to separate one or more cell types from another is contemplated. In some embodiments, methods of isolating progenitor stem cells for each other is contemplated.

In some embodiments, the device may be used to concentrate at least one analyte. As used herein, “concentrating” refers to the reduction of fluid volume per particle/analyte in the fluid. The methods and devices of the present invention allow a fluid to be concentrated or diluted. When the methods and devices are used to concentrate a fluid, it is noted that particles in one portion of the fluid becomes “concentrated” and that particles in the second portion of the fluid becomes “diluted”.

In some embodiments, the at least one insulating flow structure 20 is configured to selectively separate a first analyte from the fluid, and allows passage of a second analyte. In some embodiments the insulator-based dielectrophoresis device 12 includes a plurality of insulating flow structures 20 within the fluid flow channel 14, where each of the insulating flow structures 20 are configured to form one or more constriction 26 in the fluid flow channel 14. In some embodiments, the number of insulating flow structures 20 are determined by the number of analytes to be separated. In some embodiments, the insulator-based dielectrophoresis devices includes at least 2 insulating flow structures, or at least 3, or at least 4, or at least 5, or at least 10, or less than 15, or less than 20, or less than 30, or less than 40, or less than 50, or more.

In some embodiments, the insulating flow structure 20 is composed of an insulating material, such as a polymer (e.g., PDMS), glass, silicon, or combinations thereof.

In some embodiments, the system 10 comprises an insulating flow structure 20 comprises a multi-length scale structure. This multi-length scale structure provides improved resolution and separation of analytes. In some embodiments, the multi-length scale structure comprises an elliptically-shaped base insulator and small elliptically shaped insulators (projections) across part of the elliptically-shaped base. The size of the multi-length scale insulators is dependent on the size of the microchannel. In some embodiments, the small elliptically shaped insulators are 50 nm to 50 μm tall and/or wide at the base and as small as 5 nm wide at the top.

In some embodiments, the small elliptically shaped insulators cover part of the substrate 11. In some embodiments, “part” of the substrate 11 is at least 1-100% of the base, more preferably a little less than half (35-45%) of the surface of the base. The shape is not limited to ellipses and can include, but is not limited to: circles, triangles, rectangles, and so forth. Additionally, any combination of these can also be used.

In some embodiments, the multi-length scale structure comprises a base structure in a shape selected from the group consisting of circles, ellipses, rectangles, squares, triangles, and curves, including an inverse 20× curve. In some embodiments, the base structure is covered with insulators (projections) that are of a shape selected from the group consisting of circles, ellipses, rectangles, squares, triangles, and curves, including an inverse 20× curve.

In some embodiments, the multi-length scale structure provides improved particle streamlines, improved separation and improved resolution of analytes. In some embodiments, the structures reduce and/or eliminate extraneous trapping zones. As used herein, “trapping zone” describes the point in the fluid flow channels 14 where analytes of interest are stationary as a balance point between electrokinetic force and dielectrophoretic force. The “trapping zone” can also be described when a particle's velocity along the field line is zero. This leads to trapping occurring when the ratio of the electrokinetic and dielectrophoretic mobilities is greater than or equal to the ratio of the gradient of the electric field squared to the electric field,

$$\frac{∇ {\vert \vec{E} \vert}^{2}}{{E}^{2}} \cdot \vec{E} \geq \frac{{μ}_{E K}}{{μ}_{D E P}} .$$

As shown in FIG. 1, “trapping” may be induced by the structure of the at least one insulating flow structure.

In some embodiments, the device using the multi-length scale structure provides a high ∇| [symbol] |² as to provide enhanced resolution of analytes. The ∇| [symbol] |² may range between 10¹² and 10²³ V²/m³. The ∇| [symbol] |² to influence particles behavior depends on the size of the analytes of interest. Lower ∇| [symbol] |² are able to influence the larger particles (^{˜}1-50 μm), while higher ∇| [symbol] |² may influence smaller particles (^{˜}10-1000 nm).

In some embodiments, the device 12 can be used for scientific research or diagnostic purposes. The device 12 may be used for separation of bioparticles, including proteins or cells. For example, the devices of the present invention may be used to determine a type of bacterial infection by separating different serotypes of drug-resistant and susceptible bacteria from a sample. This would allow for rapid diagnosis of bacterial infections to insure the correct antibiotic is administered. The present device 12 is small and portable and would reduce the time for diagnosis as opposed to the standard technique of culturing the bacteria.

In some embodiments, the system 10 further includes a control system (not shown) in electrical communication with at least one of a memory, the electrochemical sensor 28, the electrodes (e.g., 38, 39, 40, the optionally additional electrode) and the power supply. In some embodiments, the control system is configured to execute instructions stored within the memory to cause the control system to detect the detectable signal produced from the analyte passing through the pore of the electrochemical sensor, and output a metric indicative of the analyte based on the detectable signal. In some embodiments, the metric indicative of the analyte includes the analyte's identity or physiochemical property, such as size, charge, charge distribution, charge polarity, conformation, monomer sequence in a polymer, polymer branching, particle coating, conformational stability, pKa, shape, passage time through the pore, mobility, interaction with the pore or other species in solution, or combinations thereof.

In some embodiments, the detectable signal includes a resistive pulse indicative of the analyte bouncing against the pore 30. In some embodiments, the pore 30 includes a functional group that binds the analyte, and where the detectable signal is indicative of a captured analyte within the pore.

In some embodiments, the system 10 includes an array of electrochemical sensors 28. In some embodiments, each electrochemical sensor 28 is configured to constrict the flow of fluid in the fluid flow channel 14 through a respective pore 30, where the respective pore is sized to produce a detectable signal upon passage of an analyte through the pore 30.

The device of the present invention is small and portable. It does not require any specific immuno- or geno-recognition or cold-chain products to separate out analytes. In some embodiments, the device can be used in a one-step diagnostic device for use in a number of clinical fields.

In some embodiments, the methods and devices of the invention can be used to separate out cells based on their biophysical characteristics.

In other embodiments, the devices and methods can be used for crystallography to efficiently separate out various sizes of crystals. For various crystallography methods, narrow crystal size ranges are needed.

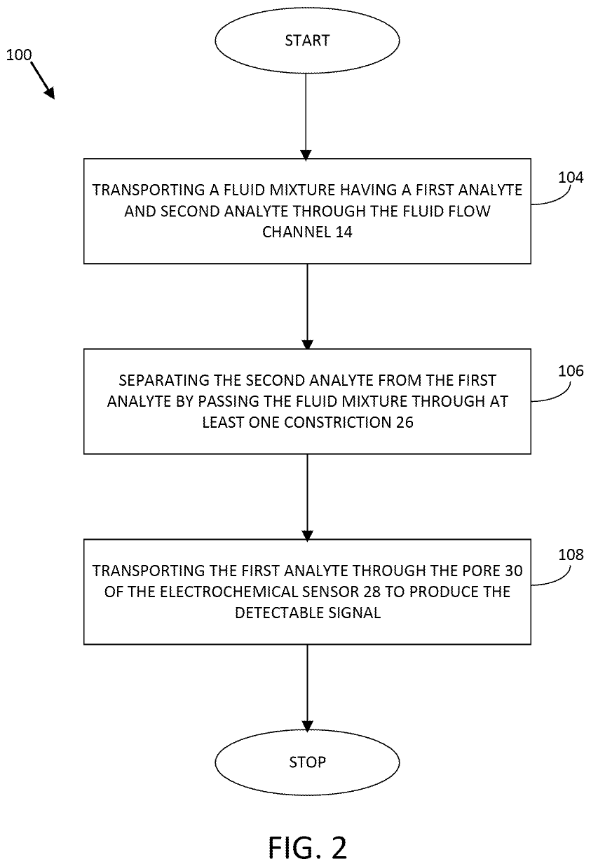

Referring to FIG. 2, some embodiments of the present disclosure provide a method 100 of separating and/or characterizing a first analyte from at least one other analyte in a fluid mixture. As indicated by step 102, the method 100 includes transporting the fluid mixture comprising a first analyte and at least a second analyte through the fluid flow channel 14. The second analyte is separated from the first analyte by passing the fluid mixture through at least one constriction 26 of an insulating flow structure 20 in the fluid flow channel 14, as indicated by step 104. The second analyte may be selectively separated from the first analyte based on the trapping zone of the insulating flow structure 20. That is to say, the first analyte passes through the trapping zone of the insulating flow structure 20, and the second analyte is selectively trapped. During separating, the gate or valve to the one or more detection chamber 32 may be in the closed position to prevent analytes from passing into the detection chamber 32. As indicated by step 106, the method 100 further includes transporting the first analyte through the pore 30 of the at least one electrochemical sensor 28 to produce the detectable signal. Prior to initiating step 106, the gate or valve to the one or more detection chamber 32 may be transitioned into the open position to allow passage of analytes into the detection chamber 32. The method 100 may include transporting the first analyte through pore 30 by manipulating the spatially non-uniform electric field to bias the first analyte toward pore 30, e.g., biasing the spatially non-uniform electric field between electrodes 38 and 40, between 39 and 40, between the optional additional electrode and 40, or combinations thereof. The method 100 may further include detecting the detectable signal using the electrochemical sensor 28 and outputting a metric indicative of the analyte based on the detectable signal. The method 100 may produce the detectable signal by bouncing the analyte against the pore 30.

In some embodiments, the method 100 includes generating a nonuniform electric field in the device 12 by applying a voltage from 1 to 3000 V to the electrodes 38, 39. In some embodiments, the method 100 includes generating a nonuniform electric field in the device 12 by applying a voltage of at least 1 V, at least 100V, at least 500 V, at least 1000 V, at least 1500 V, to less than 2000 V, less than 2500 V, or less than 3000 V.

In some embodiments, the method 100 includes flowing the mixture through the fluid flow channel 14 at a flow rate from 1 micron/s to 2 mm/s. In some embodiments, the method 100 includes flowing the mixture through the fluid flow channel 14 at a rate of at least 1 micron/s, at least 50 micron/s, at least 100 micron/s, at least 200 micron/s, at least 300 micron/s, at least 400 micron/s, at least 500 micron/s, at least 600 micron/s, at least 700 micron/s, at least 800 micron/s, at least 900 micron/s, to less than 1 mm/s, less than 1.5 mm/s, or less than 2 mm/s.

In some embodiments, the method 100 includes concentrating the first analyte in a trapping zone of an insulating flow structure 20 or trapping multiple analytes at various insulating flow structures 20 in the device 10. In some embodiments, the insulating flow structure 20 may trap a single analyte or any desired number of analytes in the trapping zone. For example, the method 100 includes concentrating at least one analyte in the trapping zone of an insulating flow structure 20, or at least 10 analytes, at least 100 analytes, at least 200 analytes, at least 300 analytes, at least 400 analytes, at least 500 analytes, at least 600 analytes, at least 700 analytes, at least 800 analytes, at least 900 analytes, to less than 1000 analytes, less than 5000 analytes, or less than 10,000 analytes.

In some embodiments, the method 100 includes regulating the temperature of the device 10 during separating. In some embodiments, the method 100 includes operating the device 10 at a temperature that ranges from room temperature (e.g., 20° C.-23° C.) to 80° C.

In some embodiments, the method 100 includes applying a pressure gradient or a salt gradient across the device 10 to enhance or otherwise control sensing rates.

In some embodiments, the method 100 includes using the electrochemical sensor 28 to sense the target analyte at different levels of concentration, which can be used for construction of a calibration curve to obtain a sensitivity of the electrochemical sensor 28.

### Examples

The following examples will enable one of skill in the art to more readily understand the principles thereof. The following examples are presented by way of illustration and are not meant to be limiting in any way.

### Exemplary System:

In this example, a system is provided allows for simultaneous separation and concentration that delivers pure sample fractions (e.g., analytes sized from 3 nm to 10 microns) to nanopore sensing elements in a fluid flow channel of an g-iDEP device. The nanopore formed a nanofluidic channel with dimensions in all directions that are less than 100 nm, which was suitably sized such that the nanopore can be used to deliver a host of capabilities for single-molecule and single-particle sensing. The nanopore formed a sole path connecting two reservoirs containing electrolyte solutions in the fluid flow channel. Ionic aqueous solution allows conduction between electrodes at differing potentials in each reservoir establishing a potential difference across the nanopore that drives ions through the nanopore. Passage of a target molecule, nanoparticle, or complex against, into, or through the nanopore perturbs that ionic current and provides molecular-level information.

Conductance blockage frequency is a readout of analyte concentration, and the blockage metrics can reveal the target's identity, dimensions, and physicochemical properties, although in a complex sample matrix the ability to definitively identify a molecular sample will be substantially compromised without a preliminary separation step such as dielectrophoresis. The example system includes a gradient insulator-based dielectrophoresis (g-iDEP) and provides an ultrahigh resolution electric field-based separation of particles in a microfluidic device.

The location where particles collect is a deterministic reflection of their electrophysical properties. It can provide high resolution unbiased characterization, isolation, concentration and purification of sub-micron particles. This technique uses a unique buffer-filled open channel on the micron-scale that induces specific patterns of electric field strength. These carefully designed field patterns cause the electrophoretic and dielectrophoretic forces associated with the particles to be counterbalanced. Each ‘pinch point’, also described as a gate, creates a zone of unique electric field characteristics which, in turn, capture only those particles whose electrophysical signature matches the properties in that zone exactly.

The combined g-iDEP and nanopore (e.g., resistive pulse sensing) sensing method operate aqueous buffer and exploit electrokinetic mechanisms to deliver sample isolation and concentration, and sensing, respectively. Device operation and readout is all-electronic, sample handling is naturally microfluidic, and separation and detection is of the native analytes, so that no preliminary sample treatment, modification, or labelling of the sample is required. The compact device footprints and integrated fluidic and electronic components allow for straightforward programmability (and reprogrammability) of the devices to respond to the challenges of a particular target species, or collection of targets. Dielectrophoresis is typically coupled with spectroscopic or imaging elements to sense the collected species, creating significantly increased volume footprint, reduction in capabilities due to integration and increased operational complexity. The size, shape and operation of the nanopore sensing perfectly marries to dielectrophoretic schemes in a variety of potentially powerful and flexible layouts.

### Nanoparticle Discrimination:

Two 3 nm gold nanoparticles differing only in the outermost functional group of their surface coating (—(CH₂CH₂O)₄₃—CH₂CH₂—COOH versus —(CH₂CH₂O)₄₃—CH₂CH₂—NH₂), were used as the targets for the separation and detection. This three-atom difference permits a stringent test of the g-iDEP separation and provides two unique particle types for nanopore detection efficiency in response to surface termination.

Physicochemical parameters of the electrochemical sensor were tuned, or otherwise adjusted, for gold nanoparticles, for example the nanopore size and surface chemistry of the pore, voltage magnitude and polarity of the device were optimized for gold nanoparticles. Both single nanoparticle type and mixed sample experiments were performed. Separation performance was evaluated by collecting liquid fractions from the device and analyzing the contents by conventional means including those outlined above.

Detection performance was conducted by comparing detection rates in single-component and mixed samples, before exploiting the single-molecule sensitivity of the nanopore to evaluate the samples purified and concentrated by g-iDEP. Calibration curves to yield sensitivity from nanopore measurements were constructed. Fluidic and nanopore construction and operating parameters were tuned to accept g-iDEP-extracted samples.

While nanopore sensing is sensitive to single molecules, it typically requires analyte concentrations greater than nanomolar in order to achieve reasonable analyte count rates, so that the ability of g-iDEP to concentrate analytes by several orders of magnitude significantly improves the sensing capabilities of the combined approach. The degree of concentration required by the initial g-iDEP step was tuned based on sensitivity studies. The use of internal standards, a conventional tool of chemical analysis, was explored as a means to increase the native reproducibility of the nanopore measurements. Similarly, conventional analytical metrics—sensitivity, selectivity, signal-to-noise, signal information content—were optimized through an iterative process.

E. coli Discrimination:

g-iDEP and nanopore sensing may be used to discriminate between strains of E. coli. These micron-scale targets are near the size limit for proposed operation of the devices, and are much larger than the nanopores to be used for nanoparticle detection. While resistive-pulse sensing using micrometer-diameter holes is used clinically to count red blood cells (Coulter counting), the experiment here is focused on a more general sensor platform. The nanopores are used for detection, post-g-iDEP separation, even though the targets will no longer be able to pass through the nanopores. Here, two sensing paradigms are possible: detection of microbes “bouncing” against the nanopore giving rise to shorter resistive pulses, and detection of microbes by transient capture (“anchoring”) of their surface decorations in the nanopore. Here there exists a range of surface decorations on microbe surfaces, so that if the “anchoring” sensing paradigm is chosen, it may be possible to use the nanopore to profile the surface coating at the molecular scale using the nanopore. The advantage of single-molecule sensing here is profound, because it can readily allow signal subpopulations that are obscured in ensemble measurements to avoid being convolved in the first place. “Bouncing” should permit higher-throughput measurements, whereas “anchoring” will be slower but likely at higher signal-to-noise albeit with a wider range of signal characteristic.

### Applications:

The present examples illustrate that the systems and methods described herein may be used to separate and characterize and/or detect a myriad of target analytes using a non-biased and fully programmable sensing element and g-iDEP device. The provided systems and methods may be used in a wide variety of applications. For example, the provided systems and methods may be used to monitor a diverse range of chemical and biological species and signals, from a myriad of stationary and mobile locations. Single molecules, nanoparticles, viruses, and microbes are all targets of interest. The provided system and methods may also be used in “internet of things” (IoT) devices (e.g., smart cities/technologies) that are equipped with the provided systems and methods. Example IoT devices include, but are not limited to, infrastructure elements such as light and electricity posts, plumbing (e.g., “smart toilets,” and drains to monitor human health and environmental risk), water supplies (at a level of large-scale water treatment plants and “smart taps” in the home), mobile human agents detected from wearable sensors.

The systems and methods described herein are fully electronic and programmable (the capture conditions in the dielectrophoresis module can be varied (dramatically) by simply changing the applied voltage or altering the frequency. Further, since the technology can enhance concentration, a large dynamic range of concentrations can be addressed, and low detection limits attained. The system can generate ubiquitous information about the environment (made or natural) and will likely generate interpretable signals from virtually any disturbance. The system may be highly deployable, as it is fully electronic, made of common materials which can be mass produced.

The present disclosure has described one or more preferred aspects, and it should be appreciated that many equivalents, alternatives, variations, and modifications, aside from those expressly stated, are possible and within the scope of the invention.

We claim:

1. A system comprising:
an insulator-based dielectrophoresis device comprising
(i) a fluid flow channel defined by a first substrate surface and a second substrate surface spaced from the first substrate surface, the fluid flow channel having at least one fluid inlet and at least one fluid outlet,
(ii) at least one insulating flow structure extending from the first substrate surface toward the second substrate surface thereby defining a constriction in the fluid flow channel between the first substrate surface and the second substrate surface;
a detection chamber placed in fluid communication with the fluid flow channel by an opening in either the first substrate surface or the second substrate surface, wherein the opening is configured downstream of the at least one insulating flow structure, wherein the detection chamber includes an electrochemical sensor configured to constrict the flow of fluid entering the detection chamber through a pore, wherein the pore is sized to produce a detectable signal upon passage of one or more analyte through the pore;
electrodes in electrical communication with the at least one fluid channel inlet and the at least one fluid outlet of the fluid flow channel, wherein the electrodes are positioned to generate a spatially non-uniform electric field across the insulating flow structure of the fluid flow channel to exert a dielectrophoretic force on the one or more analyte suspended in the fluid within the fluid flow channel; and
a power supply connected to each of the electrodes to generate an electric field within the fluid flow channel.

2. The system of claim 1, wherein the pore is a nanopore.

3. The system of claim 2, wherein the nanopore has a diameter that is no more 100 nm wide in diameter, or no more than 50 nm wide in diameter, or no more than 40 nm wide in diameter, or no more than 30 nm wide in diameter, or no more than 20 nm wide in diameter, or no more than 10 nm wide in diameter.

4. The system of claim 1, wherein the pore is a micropore.

5. The system of claim 4, wherein the micropore has a diameter that is no more than 100 μm in diameter, or no more than 50 μm wide in diameter, or no more than 40 μm wide in diameter, or no more than 30 μm wide in diameter, or no more than 20 μm wide in diameter, or no more than 10 μm wide in diameter.

6. The system of claim 1, wherein the fluid flow channel includes a first insulating flow structure and a second insulating flow structure, and wherein the detection chamber is positioned between the first insulation flow structure and the second insulating flow structure.

7. The system of claim 1, wherein the electrochemical sensor includes a substrate formed from a material selected from a polymer, silicon nitride, graphene, or molybdenum disulfide.

8. The system of claim 1, wherein the pore includes a functional group coupled to a surface of the pore.

9. The system of claim 8, wherein the functional group is an organic molecule, a protein, or a material compatible with atomic layer deposition selected from HfO₂, TiO₂, a sulfide, alumina, a silicate, a perovskite, or combinations thereof.

10. The system of claim 1, wherein the at least one insulating flow structure is configured to selectively separate a first analyte from the fluid, and allows passage of a second analyte.

11. The system of claim 1, wherein the insulator-based dielectrophoresis device includes a plurality of insulating flow structures in the fluid channel, wherein each of the plurality of insulating flow structures are configured to form a constriction in the fluid flow channel.

12. The system of claim 11, wherein the plurality of insulating flow structures includes a first insulating flow structure configured to selectively separate a first analyte from the fluid flow channel, and a second insulating flow structure configured to selectively separate a second analyte from the fluid flow channel, wherein the first insulating flow structure and the second insulating flow structure each have a constriction that allows passage of a third analyte.

13. The system of claim 1, wherein the fluid flow channel is a microchannel or a nanochannel.

14. The system of claim 1 further including a control system in electrical communication with a memory, the electrochemical sensor, the electrodes, and the power supply, the control system configured to execute instructions stored within the memory to cause the control system to:
detect the detectable signal produced from the analyte passing through the pore of the electrochemical sensor; and
output a metric indicative of the analyte based on the detectable signal.

15. The system of claim 14, wherein the metric indicative of the analyte includes identification of the analyte, size, charge, charge distribution, charge polarity, conformation, monomer sequence in a polymer, polymer branching, particle coating, conformational stability, pKa, shape, passage time through the pore, mobility, interaction with the pore or other species in solution, or combinations thereof.

16. The system of claim 14, wherein the detectable signal includes a resistive pulse indicative of the analyte bouncing against the pore.

17. The system of claim 16, wherein the pore includes a functional group that binds the analyte, and wherein the detectable signal is indicative of a captured analyte within the pore.

18. The system of claim 1 comprising an array of electrochemical sensors, each configured to constrict the flow of fluid in the fluid flow channel through a respective pore, wherein the respective pore is sized to produce a detectable signal upon passage of an analyte through the pore.

19. A method of separating and characterizing a first analyte from at least a second analyte in a fluid mixture, the method comprising:
(i) transporting a fluid mixture comprising a first analyte and at least a second analyte through a system comprising:
an insulator-based dielectrophoresis device comprising:
a fluid flow channel defined by a first substrate surface and a second substrate surface spaced from the first substrate surface, the fluid flow channel having at least one fluid inlet and at least one fluid outlet;
at least one insulating flow structure extending from the first substrate surface toward the second substrate surface thereby defining a constriction in the fluid flow channel between the first substrate surface and the second substrate surface;
a detection chamber placed in fluid communication with the fluid flow channel by an opening in either the first substrate surface or the second substrate surface, wherein the opening is configured downstream of the at least one insulating flow structure, wherein the detection chamber includes an electrochemical sensor configured to constrict the flow of fluid entering the detection chamber through a pore, wherein the pore is sized to produce a detectable signal upon passage of one or more analyte through the pore;
electrodes in electrical communication with the at least one fluid channel inlet and the at least one fluid outlet of the fluid flow channel, wherein the electrodes are positioned to generate a spatially non-uniform electric field across the insulating flow structure of the fluid flow channel to exert a dielectrophoretic force on the one or more analyte suspended in the fluid within the fluid flow channel;
a power supply connected to each of the electrodes to generate an electric field within the fluid flow channel;
(ii) separating at least the second analyte from the first analyte by passing the fluid mixture through the constriction; and
(iii) transporting the first analyte through the pore of the electrochemical sensor to produce the detectable signal.

20. The method of claim 19 further comprising detecting the detectable signal using the electrochemical sensor, and outputting a metric indicative of the analyte based on the detectable signal.
